(19) United States
(12) Patent Application Publication
(10) Pub. No.: US 2026/0077523 A1
(43) Pub. Date: Mar. 19, 2026

(54) RAZOR CARTRIDGE

(71) Applicant: DORCO CO., LTD., Seoul (KR)

(72) Inventors: Ji Hun KI, Seoul (KR); Da Woon HAN, Seoul (KR); Sang Hun PARK, Seoul (KR)

(21) Appl. No.: 19/400,466

(22) Filed: Nov. 25, 2025

Related U.S. Application Data
(63) Continuation of application No. PCT/KR2024/007102, filed on May 24, 2024.

(30) Foreign Application Priority Data
May 26, 2023 (KR) 10-2023-0068696
Jul. 21, 2023 (KR) 10-2023-0095160

(51) Int. Cl. B26B 21/44; B26B 21/22; B26B 21/40

(52) U.S. Cl. CPC B26B 21/443; B26B 21/222; B26B 21/4018

(57) ABSTRACT

A razor cartridge is proposed. The razor cartridge may include at least one blade having a cutting edge. The razor cartridge may also include a blade housing which accommodates the blade in the longitudinal direction and includes a top surface on which the blade is disposed and a bottom surface facing the top surface. The razor cartridge may further include a lubricating member accommodated in the blade housing so as to be disposed behind the blade with respect to the shaving direction. The lubricating member may include a skin contact part exposed from the top surface of the blade housing and a body part extending from the skin contact part toward the bottom surface of the blade housing. The blade housing may include a groove formed on the rear surface of the blade housing to expose at least a portion of the body part and the skin contact part.

### CROSS REFERENCE TO RELATED APPLICATIONS

This is a continuation application of International Patent Application No. PCT/KR2024/007102 filed on May 24, 2024, which claims priority to Korean patent application No. 10-2023-0068696 filed on May 26, 2023 and Korean patent application No. 10-2023-0095160 filed on Jul. 21, 2023, contents of each of which are incorporated herein by reference in their entireties.

### TECHNICAL FIELD

The disclosure relates to a razor cartridge, and more particularly to a razor cartridge in which at least one blade is accommodated.

### DESCRIPTION OF RELATED TECHNOLOGY

In general, a razor refers to a product for cutting body hair such as fuzz and stubble on a face or body, and includes a razor handle for a grip, and a razor cartridge with a blade that comes into contact with skin to have a shave.

### SUMMARY

One aspect is a razor cartridge in which the deformation of a lubrication band is minimized.

The aspects of the disclosure are not limited to those described herein, and other aspects not mentioned herein may become apparent to those skilled in the art from the following description.

Another aspect is a razor cartridge that includes: at least one blade formed with a cutting edge; a blade housing configured to accommodate the blade in a longitudinal direction, and including an upper surface on which the blade is arranged, and a lower surface opposite to the upper surface; and a lubricating member accommodated in the blade housing to be disposed behind the blade with respect to a shaving direction, wherein the lubricating member includes a skin contact portion exposed to the upper surface of the blade housing, and a body portion extending from the skin contact portion toward the lower surface of the blade housing, and the blade housing includes a groove formed on a rear surface of the blade housing to expose at least a portion of the body portion and the skin contact portion.

Other details of the disclosure are included in the detailed description and the accompanying drawings.

According to the embodiments of the disclosure, the effects are at least as follows.

The razor cartridge is improved in ability to discharge moisture and similar substances absorbed in the lubricating member, and allows the lubricating member to be rapidly dried.

The razor cartridge minimizes the deformation of the lubricating member due to moisture absorption and similar substances, and prevents the deterioration of the shaving performance due to change in the shaving plane caused by the deformation of the lubricating member, thereby exhibiting consistent shaving performance.

The effects of the disclosure are not limited to those described above, and various other effects are included in the foregoing description.

### BRIEF DESCRIPTION OF THE DRAWINGS

FIG. 1 is a perspective view showing a razor cartridge according to an embodiment of the disclosure.

FIG. 2 is an exploded perspective view showing a razor cartridge according to an embodiment of the disclosure.

FIG. 3 is a rear view showing a rear surface of a razor cartridge according to an embodiment of the disclosure.

FIG. 4 is a perspective cut-away view taken along line ‘AA’ in FIG. 1 without blades.

FIG. 5 is a perspective cut-away view taken along line ‘BB’ in FIG. 1 without blades.

FIG. 6 is a perspective view showing the bottom of a blade housing according to an embodiment of the disclosure.

FIG. 7 is a perspective view showing a razor cartridge according to another embodiment of the disclosure.

FIG. 8 is an exploded perspective view showing a razor cartridge according to another embodiment of the disclosure.

FIG. 9 is an enlarged view of ‘I’ in FIG. 8.

FIG. 10 is a rear view showing a rear surface of a razor cartridge according to another embodiment of the disclosure.

FIG. 11 is a perspective cut-away view taken along line ‘CC’ in FIG. 7 without blades.

FIG. 12 is a perspective view showing the bottom of a blade housing according to another embodiment of the disclosure.

FIG. 13 is a perspective cut-away view taken along line ‘DD’ in FIG. 7.

### DETAILED DESCRIPTION

Among the razor cartridges, there is a product that includes a lubricating member in the rear of the blade with respect to a shaving direction. The lubricating member holds a lubricating material to protect the skin and applies the lubricating material onto the surface of the skin shaved by the blade.

The lubricating member expands by absorbing moisture during a shaving process or a cleaning process. The expansion of the lubricating member causes the lubricating member to be deformed, which degrades shaving performance.

Generally, the lubricating member, together with a guard located in front of the blade, defines a shaving plane. A relative position between the blade and the shaving plane directly affects the shaving performance.

However, the expansion of the lubricating member causes change in the shaving plane, and thus the relative position between the blade and the shaving plane is also changed, thereby deteriorating the shaving performance.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor cartridge according to an embodiment of the disclosure will be described with reference to the accompanying drawings.

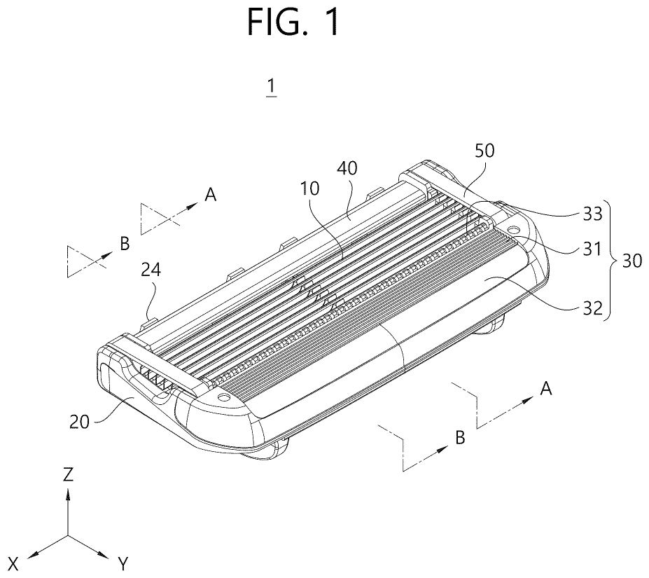

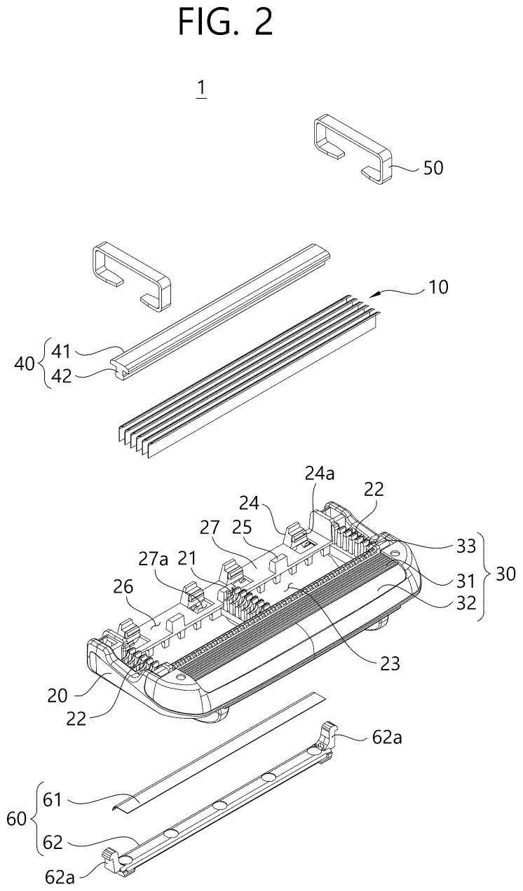

FIG. 1 is a perspective view showing a razor cartridge according to an embodiment of the disclosure, and FIG. 2 is an exploded perspective view showing a razor cartridge according to an embodiment of the disclosure.

Referring to FIGS. 1 and 2, a razor cartridge 1 according to an embodiment of the disclosure includes a plurality of blades 10 and a blade housing 20.

The upper surface of the blade housing 20 (to be described later) refers to a surface that comes into contact with a user's skin or faces a user's skin during a shaving process. The upper direction of the blade housing 20 refers to a direction (positive Z-axial direction) in which the lower surface is directed at the upper surface. The lower surface of the blade housing 20 refers to an opposite surface to the upper surface. The lower direction of the blade housing 20 refers to a direction (negative Z-axial direction), in which the upper surface is directed at the lower surface, i.e., an opposite direction to the upper direction. The front direction of the blade housing 20 refers to a direction (shaving direction, i.e., positive Y-axial direction) in which the blade housing 20 advances relative to a user's skin during the shaving process, and the rear direction of the blade housing 20 refers to an opposite direction (negative Y-axial direction) to the front direction.

The blade housing 20 is formed with a blade accommodating space 23 in which the plurality of blades 10 are accommodated in a longitudinal direction (X-axial direction). The blade accommodating space 23 may be formed penetrating the blade housing 20 up and down so that shaving residues introduced between the plurality of blades 10 can be easily discharged. FIGS. 1 and 2 shows an example that the razor cartridge 1 includes six blades 10, but the number of blades 10 may vary depending on embodiments.

Referring to FIG. 2, the blade housing 20 may include blade mounting portions 21, 22 thereon to which the plurality of blades 10 are mounted. The blade mounting portions may include a first blade mounting portion 21 and a second blade mounting portion 22.

The first blade mounting portion 21 may accommodate and/or support the center portion of the plurality of blades 10, and the second blade mounting portion 22 may accommodate and/or support both sides of the plurality of blades 10. The first blade mounting portion 21 may be formed to cross the blade accommodating space 23 in a transverse direction from a central region of the blade housing 20. The second blade mounting portion 22 may be formed on the opposite sides of the blade accommodating space 23 in the longitudinal direction. The first blade mounting portion 21 and the second blade mounting portion 22 may be configured to elastically support the plurality of blades 10.

According to an alternative embodiment, the blade housing 20 may exclude the first blade mounting portion 21. In this case, the plurality of blades 10 may be accommodated in and/or supported by the second blade mounting portion 22b on both sides.

Referring to FIGS. 1 and 2, the razor cartridge 1 may include a clip 50 at least partially positioned on both sides of the plurality of blade 10 and preventing the blade 10 from breaking away through an upper portion of the blade housing 20. Both ends of the clip 50 may be coupled to the blade housing 20. According to an embodiment, the clip 50 may be replaced with a separate cover member to be coupled to the upper portion of the blade housing 20.

Referring to FIGS. 1 and 2, a razor cartridge 1 includes a guard 30 provided in front of the blade 10. The guard 30 refers to a portion that comes into contact with skin before the blade 10 during a shaving process, and may have functions of pulling the skin, aligning body hair, or removing foreign substances from the skin.

For example, the guard 30 may include an elastic guard 31. During the shaving process, the elastic guard 31 is in close contact with a user's skin and pulls the skin to improve the shaving effect of the razor blade 10. In order for the elastic guard 31 to pull a user's skin more effectively, the elastic guard 31 may be formed with an embossed or engraved pattern on an upper surface thereof, and the upper surface of the elastic guard 31 may be made of an elastic material such as rubber or silicone.

For example, the guard 30 may include a first rigid guard 32. During the shaving process, the first rigid guard 32 removes foreign substances (for example, dead skin cells, excessively applied shaving lubricant, etc.) present on a user's skin, thereby improving the shaving effect. To improve the foreign substance removal effect of the first rigid guard 32, unevenness may be finely formed on the upper surface of the first rigid guard 32. As shown in FIGS. 1 and 2, the first rigid guard 32 may be placed in front of the elastic guard 31. In this case, the first rigid guard 32 first comes into contact with the skin to remove the foreign substances on the skin, and then the elastic guard 31 comes into close contact with the skin, from which the foreign substances have been removed, and pulls the skin.

For example, the guard 30 may include a second rigid guard 33. The second rigid guard 33 may include a comb guard, and the comb guard may align hair before the hair is cut by the razor blade 10. The comb guard may include uneven patterns arranged to be spaced apart in the longitudinal direction perpendicular to the shaving direction so that the body hair can be aligned in the shaving direction. Alternatively, the second rigid guard 33 may be formed to have a flat upper surface without including the uneven patterns. As shown in FIGS. 1 and 2, the second rigid guard 33 may be placed between the elastic guard 31 and the blade accommodating space 23, and may be located in front of the frontmost razor blade among the plurality of razor blades 10. It can be placed in front of the razor blade.

It has been described above by way of example that the guard 30 includes the elastic guard 31, the first rigid guard 32 and the second rigid guard 33, but the guard 30 may include at least one of the elastic guard 31, the first rigid guard 32 and the second rigid guard 33.

The guard 30 may be formed integrally with the blade housing 20, or may be formed separately from the blade housing 20 and coupled to the blade housing 20. Alternatively, some components of the guard 30 may be formed integrally with the blade housing 20 and other components may be formed separately from the blade housing 20 and coupled to the blade housing 20.

Referring to FIGS. 1 and 2, the razor cartridge 1 includes a lubricating member 40 disposed at the rear of the blade 10. The lubricating member 40 includes a lubricating material and applies the lubricating material to the surface of the skin where the blades 10 have passed during the shaving process. The lubricating material may contain ingredients to protect the skin after shaving.

The lubricating member 40 includes a skin contact portion 41 exposed through the upper surface of the blade housing 20, and a body portion 42 extending from the skin contact portion 41 toward the lower surface of the blade housing 20. The body portion 42 may be formed to have a narrower width in the transverse direction than the skin contact portion 41.

The blade housing 20 includes posts 24 and 25 spaced apart from each other in the transverse direction (Y direction) perpendicular to the longitudinal direction (X direction) and forming a lubricating member accommodating groove 26 to accommodate the lubricating member 40. The posts 24 and 25 may include a front post 25 and a rear post 24.

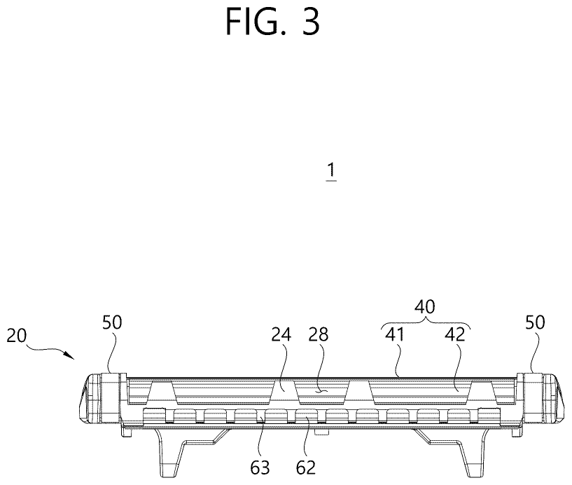

FIG. 3 is a rear view showing a rear surface of a razor cartridge according to an embodiment of the disclosure.

Referring to FIG. 3, the razor cartridge 1 includes a groove 28 formed on the rear surface of the blade housing 20. The groove 28 is formed so that at least a portion of the body portion 42 of the lubricating member 40 and the skin contact portion 41 are exposed rearward.

The groove 28 may include a plurality of grooves 28 in the longitudinal direction, and the rear post 24 may be provided on one side or both sides of each groove 28 in the longitudinal direction. In other words, the plurality of rear posts 24 are arranged to be spaced apart in the longitudinal direction, and the grooves 28 may be formed between the neighboring rear posts 24. The rear post 24 may be located at the rear of the lubricating member 40 to prevent the lubricating member 40 from breaking away rearwardly, and may be formed to extend upward so as to overlap with at least a portion of the skin contact portion 41 in a rear surface area. The rear post 24 may extend upward from the upper surface of the blade housing 20, and at least some of the rear posts 24 may extend so that their uppermost ends can cover at least a portion of the body portion 42 of the lubricating member 40 rearwardly, or may extend so that their uppermost ends can cover at least a portion of the skin contact portion 41 of the lubricating member 40 rearwardly. The rear post 24 may form the rear surface of the blade housing 20.

As shown in FIG. 3, the groove 28 may be formed to have a longitudinal width that becomes narrower downward, but is not limited thereto. Alternatively, the groove 28 may be formed to have a longitudinal width that becomes narrower upward or a longitudinal width that is constant having an approximately rectangular shape.

Each groove 28 may be formed to have a longitudinal width of about 3 mm to 9 mm, more specifically 3.7 mm to 8.89 mm. Each groove 28 may be formed to have a depth of about 2 mm or more from the upper surface of the skin contact portion 41 or the upper end of the rear post 24 so that at least a portion of the body portion 42 and the skin contact portion 41 can be exposed rearwardly. However, the shape of the groove 28 is not limited thereto, and may be modified in various ways.

In the razor cartridge 1 according to an embodiment of the embodiment, the groove 28 is formed on the rear surface, and at least a portion of the body portion 42 of the lubricating member 40 and the skin contact portion 41 of the lubricating member 40 are exposed rearwardly through the groove 28, so that moisture and similar substances absorbed in the lubricating member 40 can be easily discharged rearwardly, thereby drying the lubricating member 40 more rapidly.

Accordingly, the deformation of the lubricating member 40 due to moisture absorption or the like is minimized, thereby preventing the deterioration of the shaving performance due to change in the shaving plane caused by the deformation of the lubricating member 40.

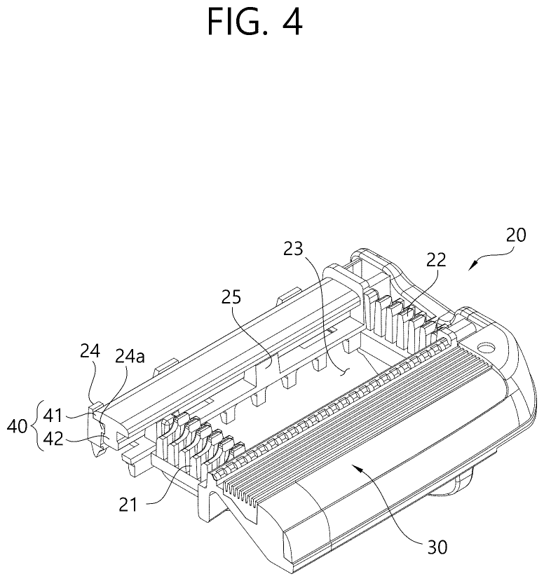

FIG. 4 is a perspective cut-away view taken along line ‘AA’ in FIG. 1 without blades.

Referring to FIGS. 2 and 4, the rear post 24 may include a stepped portion 24a protruding frontward. The stepped portion 24a may press the body portion 42 of the lubricating member 40 in the transverse and/or downward direction to hold the lubricating member 40. The lower surface of the skin contact portion 41 may be located above the stepped portion 24a and be seated on the stepped portion 24a.

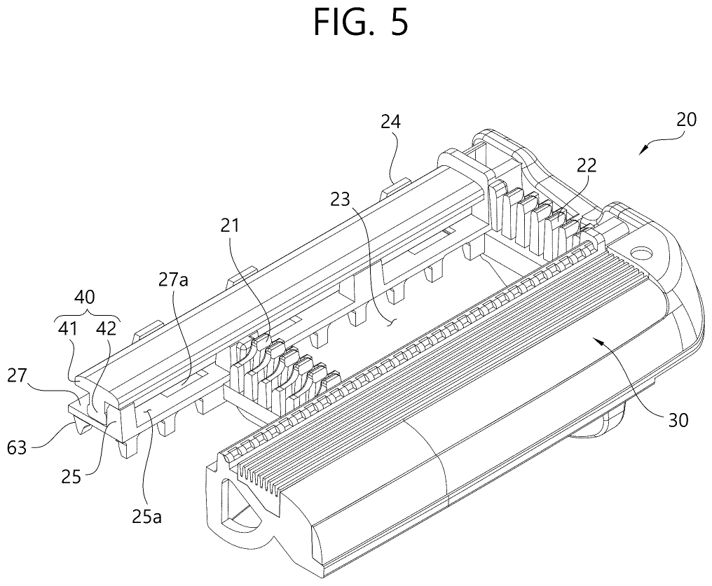

FIG. 5 is a perspective cut-away view taken along line ‘BB’ in FIG. 1 without blades.

Referring to FIGS. 2 and 5, the front post 25 may be adjacent to the blade accommodating space 23, and may be formed as a plurality of front posts 25 arranged to be spaced apart in the longitudinal direction, or as a single front post 25 extending long along the longitudinal direction.

A plurality of separation spaces 25a may be formed between the adjacent front posts 25 in the longitudinal direction. The separation space 25a may be open toward the blade accommodating space 23. In this case, the skin contact portion 41 and the body portion 42 of the lubricating member 40 are exposed toward the blade accommodating space 23 through the separation spaces 25a, and thus moisture and similar substances absorbed in the lubricating member 40 is easily discharged frontward, thereby allowing the lubricating member 40 to be dried more quickly.

Referring to FIG. 5, the front post 25 may be formed to extend upward to be close to the lower surface of the skin contact portion 41 of the lubricating member 40. Accordingly, the skin contact portion 41 of the lubricating member 40 is entirely exposed frontward, so that the lubricating member 40 can dry more quickly.

Referring to FIG. 2, the front post 25 and the rear post 24 can be arranged alternately with each other. In other words, the front post 25 and the rear post 24 may be arranged not to overlap each other in the transverse direction. Accordingly, the drying efficiency of the lubricating member 40 is improved because there is no section where both the front and rear sides of the lubricating member 40 are covered with the front and rear posts 25 and 24.

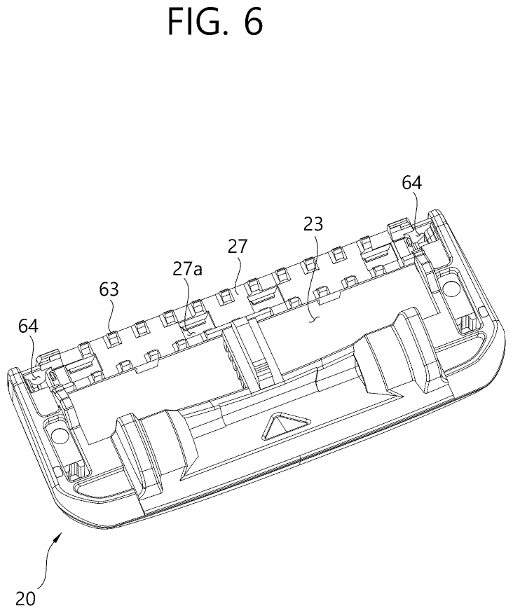

FIG. 6 is a perspective view showing the bottom of a blade housing according to an embodiment of the disclosure.

Referring to FIGS. 2 and 6, the blade housing 20 may include a downward opening 27a penetrating downward to communicate with the lubricating member accommodating groove 26. The downward opening 27a is configured to discharge downward moisture absorbed in the lubricating member 40 and quickly dry the lubricating member 40 through air circulation.

The groove 28 and the downward opening 27a may communicate with each other through the lubricating member accommodating groove 26. Further, the separation space 25a and the downward opening 27a may communicated with each other through the lubricating member accommodating groove 26.

Accordingly, moisture absorbed in the lubricating member 40 may be discharged forward, backward and downward simultaneously. Further, because the groove 28 and the downward opening 27a communicate with each other through the lubricating member accommodating groove 26, air circulation is induced around the lubricating member 40, thereby drying the lubricating member 40 rapidly.

The blade housing 20 includes a base portion 27 that forms the bottom of the lubricating member accommodating groove 26. The base portion 27 is located below the body portion 42 of the lubricating member 40. The lubricating member 40 may be accommodated in the lubricating member accommodating groove 26 so that the body portion 42 can be seated on the base portion 27. Alternatively, the lubricating member 40 may be accommodated in the lubricating member accommodating groove 26 so that the body portion 42 can be spaced apart from the base portion 27. The front post 25 and the rear post 24 may extend upward from the base portion 27. The downward opening 27a may be formed to penetrate the base portion 27 in the upward and downward directions.

Referring to FIG. 2, the downward opening 27a may be formed in the front of the rear post 24 to overlap at least a portion of the rear post 24 in the transverse direction. Alternatively, although not shown, the downward opening 27a may be formed in the rear of the front post 25 to overlap at least a portion of the front post 25 in the transverse direction. Alternatively, the downward opening 27a may be formed between the front post 25 and the rear post 24 in the longitudinal direction.

Portions of the lubricating member 40, which are covered frontwards or backwards with the front post 25 and the rear post 24, have a lower moisture discharge efficiency than portions which are open frontwards or backwards. To improve the moisture discharge efficiency in the portions of the lubricating member 40 covered with the front post 25 and the rear post 24, the downward opening 27a may be formed to overlap the front post 25 or the rear post 24 in the transverse direction. Preferably, the downward opening 27a may be formed to overlap the rear post 24, which covers more portions of the lubricating member 40 than the front post 25, in the transverse direction.

Referring to FIGS. 2 and 6, the razor cartridge 1 may further include a trimmer assembly 60.

The trimmer assembly 60 may include a trimming blade 61, a trimming supporter 62, a trimming contact portion 63, and a trimmer coupling groove 64.

The trimming blade 61 may be provided on the lower surface of the blade housing 20, and has a cutting edge exposed on the lower surface of the blade housing 20 and facing downward. The trimming blade 61 may be placed in an area opposite to an area where the lubricating member 40 is placed, with respect to the base portion 27. In other words, the lubricating member 40 may be placed in the area corresponding to the upper portion of the blade housing 20 in the base portion 27, and the trimming blade 61 may be placed in the area corresponding to the lower portion of the blade housing 20 in the base portion 27.

The trimming supporter 62 secures the trimming blade 61 to the blade housing 20. Referring to FIG. 2, the trimming supporter 62 may include trimmer coupling ends 62a on opposite lateral sides. Referring to FIG. 6, the blade housing 20 may be formed with trimmer coupling grooves 64 on the opposite lateral sides of the base portion 27 in the longitudinal direction, and the trimmer coupling ends 62a may be coupled to the trimmer coupling grooves 64.

The trimming blade 61 is located between the trimming supporter 62 and the base portion 27, and moisture discharged downward through the downward opening 27a may be discharged through a space between the trimming blade 61 and the base portion 27.

The trimming contact portion 63 may be formed on one side of the trimming supporter 62 and may protrude downward from the base portion 27. The trimming contact portion 63 is located behind the trimming blade 61 and may extend to be close to the cutting edge of the trimming blade 61. The trimming contact portion 63 may be located in front of the trimming blade 61 and may include a trimming guard. Alternatively, the trimming contact portion 63 may be located behind the trimming blade 61 and may include a trimming cap. The trimming guard and the trimming cap may be respectively placed in the front and rear of the trimming blade 61, and may come into contact with a user's skin during the trimming shaving process.

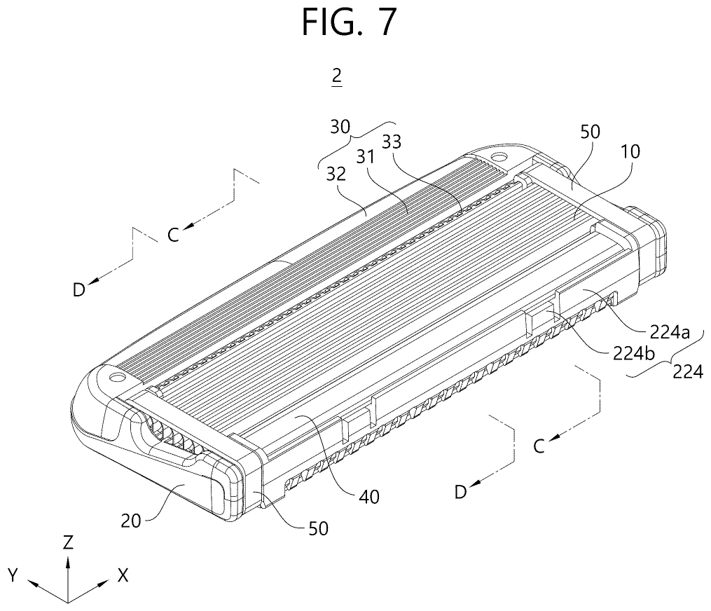

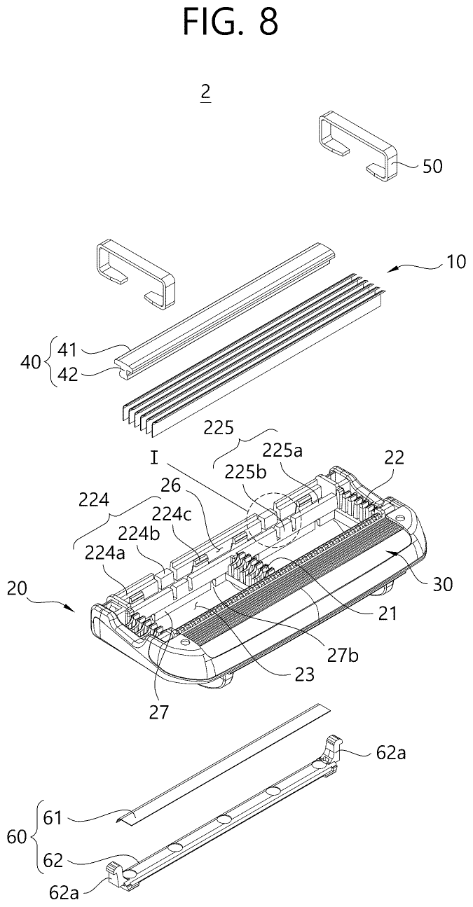

FIG. 7 is a perspective view showing a razor cartridge according to another embodiment of the disclosure, and FIG. 8 is an exploded perspective view showing a razor cartridge according to this embodiment of the disclosure.

Referring to FIGS. 7 and 8, a razor cartridge 2 according to this embodiment of the disclosure is different in the blade housing 20 from the razor cartridge 1 according to the foregoing embodiment. In more detail, the blade housing 20 according to this embodiment includes posts 224 and 225 that are different from those of the foregoing embodiment, and corresponding grooves 222 and 223 having different shapes. Because the blade 10, the guard 30, the lubricating member 40, the clip 50, and the trimmer assembly 60 are similar to those of the aforementioned embodiment, repetitive descriptions thereof will be avoided. Besides, like numerals refer to components similar to those of the aforementioned embodiment, and repetitive descriptions thereof will be avoided.

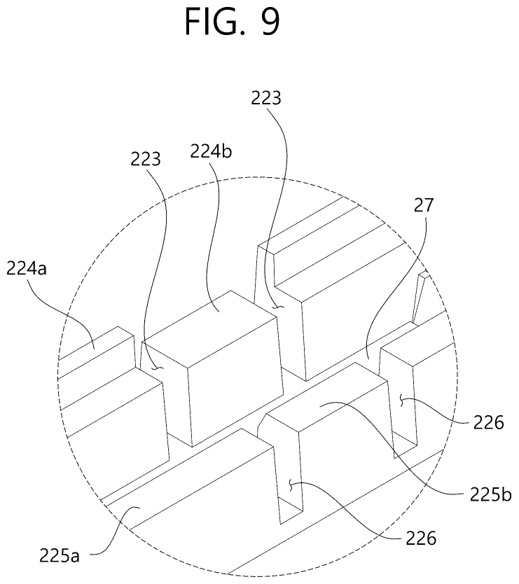

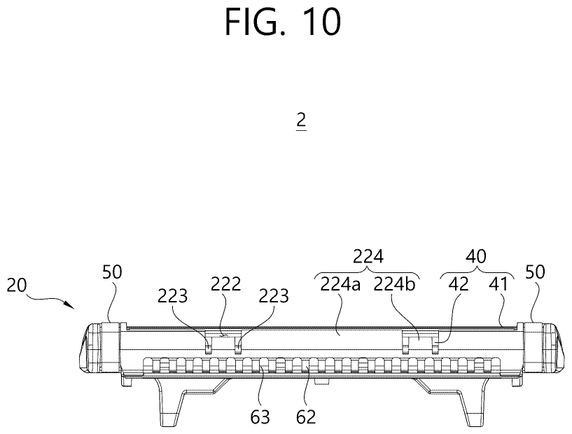

FIG. 9 is an enlarged view of ‘I’ in FIG. 8, and FIG. 10 is a rear view showing a rear surface of a razor cartridge according to another embodiment of the disclosure.

Referring to FIGS. 7 to 10, the posts 224 and 225 include a front post 225 and a rear post 224. The rear post 224 may include a first rear post 224a and a second rear post 224b. The first rear post 224a and the second rear post 224b may be arranged alternately with each other in the longitudinal direction. The rear post 224 may form the rear surface of the blade housing 20.

The first rear post 224a may be formed to extend upward from the base portion 27 so as to be adjacent to the upper surface of the skin contact portion 41 of the lubricating member 40.

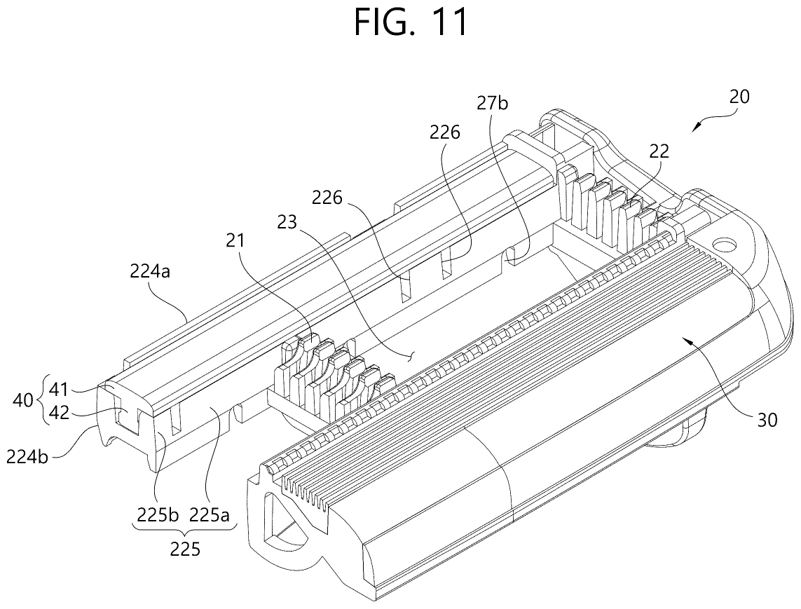

The second rear post 224b may be provided between two first rear posts 224a. The second rear post 224b may be formed to be at least partially spaced apart from the opposite first rear posts 224a. The second rear post 224b may be formed to have a lower height than the first rear post 224a. For example, the second rear post 224b may be formed to extend upward so as to be more adjacent to the lower surface of the skin contact portion 41 of the lubricating member 40 than the first rear post 224a (see FIG. 11).

Referring to FIGS. 9 and 10, the razor cartridge 2 includes grooves 222 and 223 formed on the rear surface of the blade housing 20. The grooves 222 and 223 may be formed between two first rear posts 224a. The grooves 222 and 223 may include a first groove 222 and a second groove 223.

The first groove 222 may be formed at the upper end of the second rear post 224b, and formed between the two first rear posts 224a located on opposite sides of the second rear post 224b. The skin contact portion 41 of the lubricating member 40 may be exposed rearwardly through the first groove 222.

The second grooves 223 may be formed on both lateral sides of the first groove 222. The second groove 223 may be recessed more deeply downward than the first groove 222. As shown in FIG. 10, the second groove 223 may be formed extending downward from the first groove 222. The second groove 223 may be formed by a gap between the first rear post 224a and the second rear post 224b.

The second groove 223 may have a longitudinal width of about 0.5 mm to 0.6 mm, more specifically 0.51 mm to 0.57 mm. The second groove 223 may be formed to have a depth of about 1 mm (for example, 1.4 mm) or more from the upper end of the first groove 222 so that at least a portion of the body portion 42 can be exposed rearwardly. However, the shape of the second groove 223 is not limited thereto, and may be modified in various ways.

The grooves 222 and 223 may include a plurality of grooves 222 and 223 formed in the longitudinal direction. It has been described by way of example that the second grooves 223 in this embodiment, are formed on both lateral sides of the first groove 222, but the second groove 223 may be formed on one side of the first groove 222 or the first groove 222 and the second groove 223 may be arranged in the form of ‘T’ according to alternative embodiments. Further, according to an alternative embodiment, at least a portion of the grooves 222 and 223 may include only the first groove 222 or only the second groove 223.

The razor cartridge 2 according to this embodiment also easily discharges moisture absorbed in the lubricating member 40 rearwardly through the grooves 222 and 223 formed on the rear surface, thereby drying the lubricating member 40 more quickly.

Referring to FIG. 8, the first rear post 224a may include a stepped portion 224c protruding frontward. The stepped portion 224c may secure the lubricating member 40 by pressing the body portion 42 of the lubricating member 40 in the transverse and/or downward direction. The lower surface of the skin contact portion 41 may be located above the stepped portion 224c and be seated on the stepped portion 224c.

FIG. 11 is a perspective cut-away view taken along line ‘CC’ in FIG. 7 without blades.

Referring to FIGS. 8 and 11, the front post 225 may be arranged in the longitudinal direction to be close to the blade accommodating space 23. The front post 225 may include a first front post 225a and a second front post 225b. The first front post 225a and the second front post 225b may be arranged alternately with each other in the longitudinal direction. Referring to FIG. 11, the first front post 225a and the second front post 225b may be formed to extend upward so as to close to the lower surface of the skin contact portion 41 of the lubricating member 40.

Referring to FIGS. 8 and 9, the first front post 225a may be arranged to face the first rear post 224a, and the second front post 225b may be arranged to face the second rear post 224b.

Referring to FIG. 9, gaps 226 between the first front post 225a and the second front post 225b may be arranged to align with the second grooves 223 between the first rear post 224a and the second rear post 224b in the transverse direction. This allows moisture absorbed in the lubricating member 40 to be discharged forward and backward simultaneously through the gaps 226 and the second grooves 223, and guides air to flow through the gap 226 and the second groove 223 facing each other, thereby drying the lubricating member 40 rapidly.

Referring to FIGS. 8 and 11, the gap 226 between the first front post 225a and the second front post 225b may be opened toward the blade accommodating space 23. Accordingly, moisture absorbed in the lubricating member 40 is easily discharged to the blade accommodating space 23 through the gap 226, thereby making the lubricating member 40 be dried more quickly.

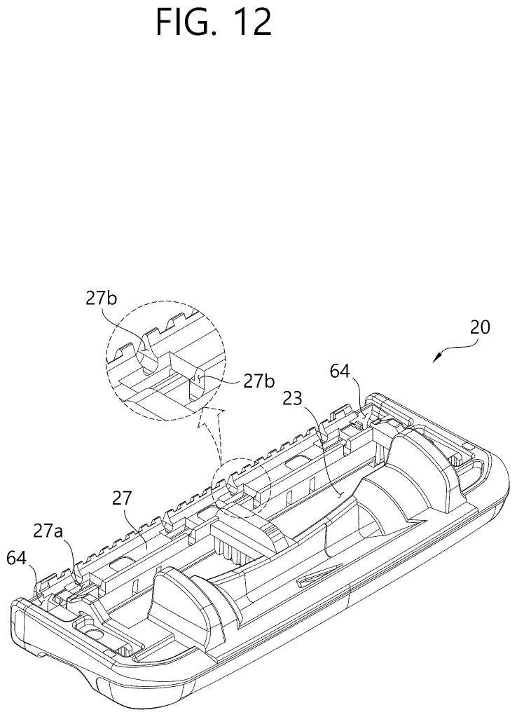

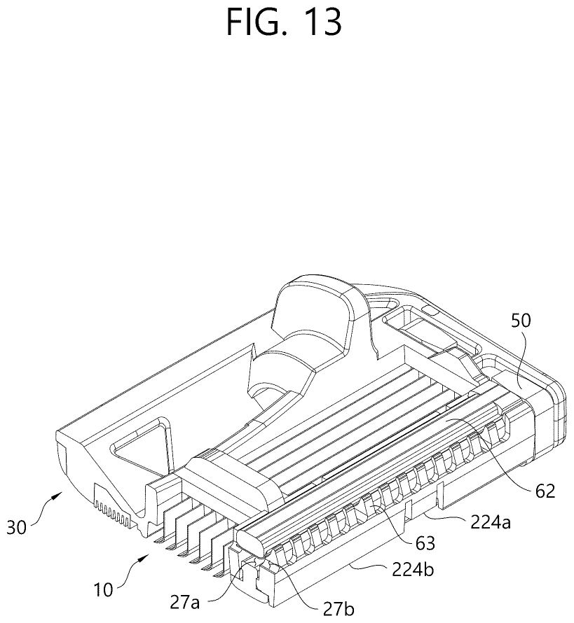

FIG. 12 is a perspective view showing the bottom of a blade housing according to another embodiment of the disclosure, and FIG. 13 is a perspective cut-away view taken along line ‘DD’ in FIG. 7.

Referring to FIGS. 12 and 13, the blade housing 20 according to this embodiment may also include a downward opening 27a penetrating the base portion 27 up and down.

The downward opening 27a may be formed to be spaced apart from the second groove 223 and the gap 226 in the longitudinal direction. In other words, the downward opening 27a may be formed not to overlap the second groove 223 and the gap 226 in the transverse direction. This is to improve the moisture discharge efficiency and drying efficiency of the lubricating member 40 by separating a moisture discharge portion based on the second groove 223 and the gap 226 and a moisture discharge portion based on the downward opening 27a in the longitudinal direction.

The blade housing 20 according to this embodiment may further include a channel 27b extending from the downward opening 27a on the lower surface of the blade housing 20 and formed forward and backward between the lower surface of the blade housing 20 and the trimmer assembly 60.

The channel 27b may be formed on the lower surface of the base portion 27 and formed to cross the downward opening 27a in the transverse direction. The channel may have a first side open toward the rear surface of the blade housing 20, and a second side open toward the blade accommodating space 23. The channel 27b may be formed between the base portion 27 and the trimmer assembly 60, e.g., the trimming blade 61.

The channel 27b may serve as a path through which moisture discharged through the downward opening 27a is discharged, or may serve as an inlet/outlet for external air to cause air to circulate around the lubricating member 40. The channel 27b may prevent the function of the downward opening 27a from being deteriorated due to the trimming blade 61 and the trimming supporter 62 placed in the lower portion of the base portion 27.

As described above, the razor cartridges 1 and 2 according to the embodiments of the disclosure include the grooves 28, 222 and 223 formed on the rear surface to expose at least a portion of the lubricating member 40 rearwardly, and the lubricating opening 27a placed below the lubricating member 40 and penetrating the blade housing 20 downward, and are thus improved in ability to discharge moisture absorbed in the lubricating member 40, thereby allowing the lubricating member 40 to be dried rapidly.

Further, the razor cartridges 1 and 2 according to the embodiments of the disclosure include the separation space 25a or the gap 226, through which moisture absorbed in the lubricating member 40 is discharged to the blade accommodating space 23, and are thus improved in ability to discharge moisture absorbed in the lubricating member 40, thereby allowing the lubricating member 40 to be dried rapidly.

Further, the razor cartridges 1 and 2 according to the embodiments of the disclosure include the channel 27b extending from the downward opening 27a and opening toward the outside of the blade housing 20, and are thus improved in ability to discharge moisture absorbed in the lubricating member 40, thereby allowing the lubricating member 40 to be dried rapidly.

The razor cartridges 1 and 2 according to the embodiments of the disclosure minimize the deformation of the lubricating member 40 due to moisture absorption, and thus prevent the deterioration of shaving performance due to change in the shaping plane caused by the deformation of the lubricating member 40, thereby exhibiting consistent shaving performance.

The following [Table 1] shows difference in the height of the lubricating member between the conventional razor cartridges and the razor cartridges 1 and 2 according to the embodiments of the disclosure before shaving and after shaving four times. The conventional 1 and the conventional 2 indicate the conventional razor cartridges without grooves, which refer to comparative models manufactured identically to the razor cartridges 1 and 2 according to the embodiments of the disclosure in the shape/material of the lubricating member, the outer appearance excluding the groove, and the like conditions except that the groove is not formed.

TABLE 1

| | | | | Another |
|---|---|---|---|---|
| | Conven- | Conven- | Embodi- | embodi- |
| | tional 1 | tional 2 | ment | ment |
| Before shaving (mm) | 2.15 | 2.15 | 2.16 | 2.16 |
| After shaving (mm) | 2.3 | 2.29 | 2.21 | 2.22 |
| Height difference (mm) | 0.15 | 0.14 | 0.05 | 0.06 |

Referring to [Table 1], the conventional razor cartridges (conventional 1, and conventional 2) were increased in the height of the lubricating member by about 7% after shaving four times in a week, whereas the razor cartridges 1 and 2 according to these embodiments were increased in the height of the lubricating member by less than about 3% after shaving four times.

In other words, the razor cartridges 1 and 2 according to the present embodiments exhibit the foregoing effects compared to the conventional razor cartridges.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor cartridge comprising:
at least one blade formed with a cutting edge;
a blade housing configured to accommodate the blade in a longitudinal direction, the blade housing comprising an upper surface on which the blade is arranged, and a lower surface opposite to the upper surface; and
a lubricating member accommodated in the blade housing to be disposed behind the blade with respect to a shaving direction,
wherein the lubricating member comprises a skin contact portion exposed to the upper surface of the blade housing, and a body portion extending from the skin contact portion toward the lower surface of the blade housing,
wherein the blade housing comprises a groove formed on a rear surface of the blade housing to expose at least a portion of the body portion and the skin contact portion,
wherein the blade housing further comprises a lubricating member accommodating groove formed to accommodate the lubricating member therein, and a downward opening extending downward through the blade housing to communicate with the lubricating member accommodating groove, and
wherein the groove and the downward opening are configured to communicate with each other through the lubricating member accommodating groove.

2. The razor cartridge of claim 1, wherein the blade housing further comprises at least one post formed on one or both longitudinal sides of the groove in the longitudinal direction and preventing rearward detachment of the lubricating member.

3. The razor cartridge of claim 2, wherein the downward opening is formed in front of the post to be aligned with the post in a transverse direction perpendicular to the longitudinal direction.

4. The razor cartridge of claim 1, further comprising a trimmer assembly comprising a trimming blade provided on the lower surface of the blade housing.

5. The razor cartridge of claim 4, further comprising a channel extending from the downward opening and defined between the lower surface of the blade housing and the trimmer assembly.

6. The razor cartridge of claim 5, wherein the channel is open toward the rear surface of the blade housing.

7. The razor cartridge of claim 5, wherein the channel is open toward a blade accommodating space in which the blade is accommodated.

8. The razor cartridge of claim 1, wherein the groove is formed to be adjacent to a lower end of the skin contact portion.

9. The razor cartridge of claim 1, wherein the groove comprises:
a first groove formed on the rear surface of the blade housing to expose the skin contact portion; and
a second groove formed on one or both sides of the first groove, recessed more deeply downward than the first groove, and formed on the rear surface of the blade housing to expose at least a portion of the body portion and at least a portion of the skin contact portion.

10. The razor cartridge of claim 1, wherein the blade housing further comprises:
front and rear posts spaced apart from each other in a transverse direction perpendicular to the longitudinal direction, and forming a lubricating member accommodating groove to accommodate the lubricating member; and
a base portion forming a bottom of the lubricating member accommodating groove, and
wherein the base portion comprises a downward opening formed to extend through the base portion to communicate with the lubricating member accommodating groove.

11. The razor cartridge of claim 10, wherein the base portion further comprises a channel recessed on a lower surface of the base portion and extending from the downward opening in the transverse direction.

12. The razor cartridge of claim 11, wherein the channel is open toward the rear surface of the blade housing.

13. The razor cartridge of claim 11, wherein the channel is open toward a blade accommodating space in which the blade is accommodated.

14. The razor cartridge of claim 10, wherein:
the rear post comprises a plurality of rear posts spaced apart in the longitudinal direction, and
the groove is formed between the neighboring rear posts.

15. The razor cartridge of claim 10, wherein the front post is arranged not to overlap the rear post in the transverse direction.
